(19) United States
(12) Patent Application Publication
(10) Pub. No.: US 2018/0357608 A1
(43) Pub. Date: Dec. 13, 2018

(54) Creating Job Profiles Using a Data Driven Approach

(71) Applicants: International Business Machines Corporation, Armonk, NY (US); Deakin University, Geelong (AU)

(72) Inventors: Bhavna Agrawal, Armonk, NY (US); Yi-Min Chee, Yorktown Heights, NY (US); Rong Liu, Sterling, VA (US); Wanita Sherchan, Clayton South (AU); Cheuk Hay Sin, Melbourne (AU); Michael Eng Yeow Tan, Melbourne (AU)

(21) Appl. No.: 15/616,868

(22) Filed: Jun. 7, 2017

(51) Int. Cl. G06Q 10/10; H04L 29/08; G06F 17/27; G06Q 10/06; G06F 17/30

(52) U.S. Cl. CPC G06Q 10/1053; H04L 67/306; G06F 17/30702; G06Q 10/063112; G06F 17/30035; G06F 17/277

(57) ABSTRACT

A method and system of characterizing a job market is provided. The available job postings of a job market are determined. For each job posting, one or more technical skills, a job role level, and one or more professional capabilities related to the job posting are determined. The professional capabilities are aggregated by job dimensions. The determined technical skills and the professional capabilities of each job posting and the aggregated professional capabilities are stored in a database as reference data. A job capability profile for one or more job dimensions is provided based on the stored reference data in the database.

### BACKGROUND

### Technical Field

The present disclosure generally relates to advanced job market analytics, and more particularly, to the computerized identification of professional capabilities based on retrieved text documents from job market postings.

### Description of the Related Art

The internet has transformed the way that jobs are made available to the job seekers. It has become a primary conduit for employment and recruitment. Profiling of open jobs in the marketplace provides a view of the salient skill sets. The current practices for job profiling typically use static skill taxonomy and rely on survey data. Another typical approach uses predetermined terms, sometimes referred to as “key-word” or “key-phrases,” to determine relevant skill sets sought by the job market. For example, the more hits there are for a predetermined term (e.g., “Java programming”), the more relevant that skill is deemed for the present market place.

### SUMMARY

According to various embodiments, a computing device, a non-transitory computer readable storage medium, and a method are provided to characterize a job market. The available job postings of a job market are determined. For each job posting, one or more technical skills, a job role level, and one or more professional capabilities related to the job posting are determined. The technical skills, job role levels, and professional capabilities are aggregated by job dimensions. The determined technical skills, job role level, and the professional capabilities of each job posting are stored in a database. A job profile for one or more job dimensions is provided.

In one embodiment, determining the one or more professional capabilities related to the job posting comprises segmenting a job description text of the job posting into one or more sentences.

In one embodiment, for each job posting, determining the one or more professional capabilities related to the job posting further includes, upon determining that a sentence of the one or more sentences is irrelevant, discarding the irrelevant sentence and identifying the remaining one or more sentences as relevant. Upon determining that a sentence of the relevant sentences has a subject of a company, the sentence having a subject of a company is discarded, and the remaining one or more sentences are identified to not having a subject as a company. One or more core capabilities from the sentences identified as not having a subject as a company are identified, based on a first set of core capabilities. One or more core capabilities from the sentences identified as not having a subject as a company and not based on the first set of core capabilities are identified, based on a second set of core capabilities.

In one embodiment, for each job posting, determining the one or more professional capabilities related to the job posting further includes determining whether there is at least one of (i) an explicit and (ii) an implicit description of a professional capability. Upon determining that there is an implicit description of a professional capability, natural language processing (NLP) is used to identify the implicit description of the professional capability.

In one embodiment sentences that do not include a technical skill or a professional capability are excluded by applying a neural network based binary natural language classifier (NLC) on the sentences.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 illustrates an example architecture for implementing a professional capabilities identification system.

FIG. 2, which is a block diagram of a system that automatically creates a job capabilities profile.

FIG. 3 which is an example capability extraction architecture, consistent with an illustrative embodiment.

FIG. 4 is a conceptual block diagram of a system that uses a job profile model to create different reports and recommendations, consistent with an illustrative embodiment.

FIG. 5 presents an illustrative process for a computerized determination of the status of a job market.

FIG. 6A illustrates an example capability profile for two different job titles.

FIG. 6B illustrates example capability profiles for different professions.

FIG. 7 provides a functional block diagram illustration of a computer hardware platform.

### DETAILED DESCRIPTION

### Overview

In the following detailed description, numerous specific details are set forth by way of examples to provide a thorough understanding of the relevant teachings. However, it should be apparent that the present teachings may be practiced without such details. In other instances, well-known methods, procedures, components, and/or circuitry have been described at a relatively high-level, without detail, to avoid unnecessarily obscuring aspects of the present teachings.

The present disclosure relates to computerized identification of professional capabilities based on retrieved text documents of job market postings. In today's dynamic job market, not only are different technical skills solicited, but also core and leadership professional capabilities for various job categories. By better understanding the present demands and trends of the job market individuals can find jobs for their current skill set and develop their capabilities for future jobs they envision in their career path; organizations can plan for salient skills as their business grows; governments can incentivize their citizens to develop the appropriate skills; and the like.

While profiling of open jobs in the marketplace provides a view of the currently needed skills, the current practices for job profiling typically use (i) static skill taxonomy and (ii) rely heavily on survey data. The former traditional approach lacks sufficient frequency and flexibility to respond to the accelerating pace of change of the job market. The latter approach is very restrictive to be able to identify the full set of needed skills, because often, skills are inferred and not explicitly stated. For example, traditional approaches would be challenged to identify that an explicitly communicated skill, such as “excellent communication skills,” is the same as an implicitly communicated skill, such as “develop and maintain a productive working relationship with project sponsors, customers, vendors, and other key stakeholders.”

In one aspect, the present disclosure describes a data driven approach to identifying professional capabilities and/or professional skills that are automatically harvested from many job postings in the current job market. As used herein, professional capabilities (which includes core and leadership capabilities) refer to soft employability skills that apply to all professions, as well as multi-disciplinary skills, such innovation, design thinking, or creativity that are common to more than one profession. Expertise capabilities are industry specific and include technical skills such as data-driven marketing and risk management. These specialist skills evolve as the profession changes. Leadership capabilities are a set of capabilities that focus on building the vision, culture, commitment and strategy of an organization. These concepts are expounded later.

These employability skills that define general employability of a person are sometimes referred to as professional capabilities, which generally relate to soft skills, personal traits, or non-cognitive skills. These professional capabilities are distinct from technical skills, such as programming skills or analytics skills, which are specific to certain types of jobs or industries. Professional capabilities can vary over time and geographic regions. The better the professional capabilities of the job market (or sectors thereof) are understood, the easier it is for an individual to transition from one job to another. Indeed, while the datasets cover a very large range of industries and jobs, they are based on rigid taxonomies of jobs/industries, and are updated very slowly because it usually involves substantial manual effort.

The present disclosure describes systems and methods that identify these professional capabilities from the job descriptions and aggregates them based on various filters that allow an interested party (e.g., organizations, government entities, universities, individuals, etc.,) to review professional capabilities in various job dimensions, such as based on title, organization, industry, job group(s), regions, or any combination thereof. The data-driven approach described herein is based on natural language processing (NLP) to automatically identify professional skills from the job description. NLP is a field of artificial intelligence, computer science, and computational linguistics that deals with the interaction between a human (i.e., the natural element) and computers. NLP processing techniques are used herein to discover capabilities stated implicitly or explicitly in the job posting text. Then, job capability profiles can be created by aggregating discovered capabilities by many dimensions such as title, industry, profession etc. By creating a relationship between capabilities and the existing jobs market, jobs can be profiled without the constraints of taxonomy. This enables timely insights into changes and trends of a job market.

In one embodiment, as new jobs come to the market, the jobs are automatically characterized for the capabilities without a need to create a new taxonomy item. Since the capability profiles of new jobs are created automatically, it is possible to identify the current professional capability trends. The profiling is not restricted to regional jobs, although one or more filters can be used to focus on a region. By virtue of profiling capabilities for a group of jobs, an interested party can identify the professional skills to foster such capabilities in their organization or sub-organizations, and plan for them accordingly.

In one aspect, deep learning techniques are used to identify professional capabilities from job descriptions. The text of each harvested job posting is segmented into sentences. Supervised classification models are developed at both sentence and job levels. NLP and classification techniques are used together to support end-to-end job profiling, which takes job postings as an input and produces job capabilities as an output, which is stored in a database and/or electronically sent to an interested party subscribed to the service described herein. Reference now is made in detail to the examples illustrated in the accompanying drawings and discussed below.

### Example Architecture

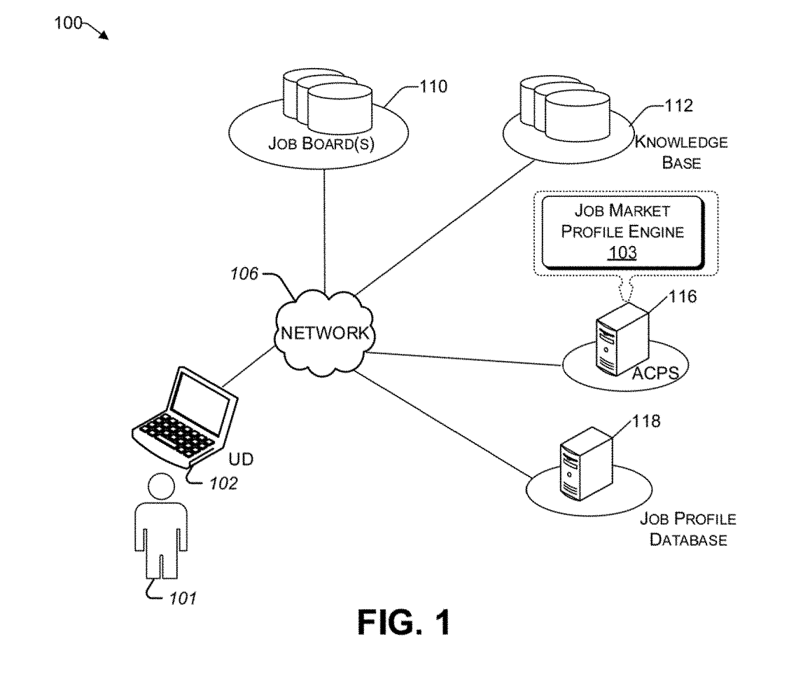

FIG. 1 illustrates an example architecture 100 for implementing a professional capabilities identification system. Architecture 100 includes a network 106 that allows one or more interested parties, represented herein by user 101, to interact with a job market profile engine that runs on an advanced capabilities profiling server (ACPS) 116. Interested parties 101 may be individuals, organizations, government entities, universities, etc. that are subscribed to the job market profile service described herein.

The network 106 may be, without limitation, a local area network (“LAN”), a virtual private network (“VPN”), a cellular network, the Internet, or a combination thereof. For example, the network 106 may include a mobile network that is communicatively coupled to a private network, sometimes referred to as an intranet that provides various ancillary services, such as communication with various application stores, libraries, and the Internet. To facilitate the present discussion, network 106 will be described, by way of example only and not by way of limitation, as a mobile network as may be operated by a carrier or service provider to provide a wide range of mobile communication services and supplemental services or features to its subscriber customers and associated mobile device users. The network 106 allows the job market profile engine 103 running on the ACPS 116 to communicate with one or more interested parties, such as user 101, over their user device (UD), such as UD 102 to receive a status of the present job market on a user interface of the UD 102.

Today, user devices typically take the form of portable handsets, smart-phones, tablet computers, personal digital assistants (PDAs), and smart watches, although they may be implemented in other form factors, including consumer, and business electronic devices.

The job market profile engine 103 running on the ACPS 116 can interact with various data resources such as one or more job boards, represented herein as job board 110. Job boards may include, but are not limited to, Indeed, Monster, LinkedIn, CareerBuilder, and the like. In addition, non-traditional job boards, including social media (Facebook, Twitter, etc.,) may be used as a source of new job announcements as well.

The job market profile engine 103 can also interact with various knowledge bases, represented herein as knowledge base 112, which is operative to provide context for a job postings. For example, a knowledge base 112 may provide a typical salary, education requirement, career trajectory, geographical constraints, and other features that may not be provided in a job posting, but can be extracted from the knowledge base 112. A knowledge base 112 may be, without limitation, a government agency that stores such statistics, or a reference site, such as Wikipedia.

In one embodiment, there is a job profile database 118 that is used by the job market profile engine 103 to store the information that is analyzed from the job board(s) 110 and the knowledge base 112. In various embodiments, the job profile database 118 may be a relational database, object database, object-relational database, and/or key-value database. Accordingly, for each job from the various job boards 110, the job market profile engine 103 can store the relevant information, together with ancillary information obtained from the knowledge base 112 in the job profile database 118.

While the job board(s) 110, the knowledge base 112, the ACPS 116 and the job profile database 118 are illustrated by way of example to be on different platforms, it will be understood that, in various embodiments, these computing platforms may be combined in various combinations. For example, the ACPS 116 and the job profile database 118 may be on a same platform. In other embodiments, one or more of these computing platforms may be implemented by virtual computing devices in the form of virtual machines or software containers that are hosted in a cloud, thereby providing an elastic architecture for processing and storage.

### Example Job Profiling Blocks

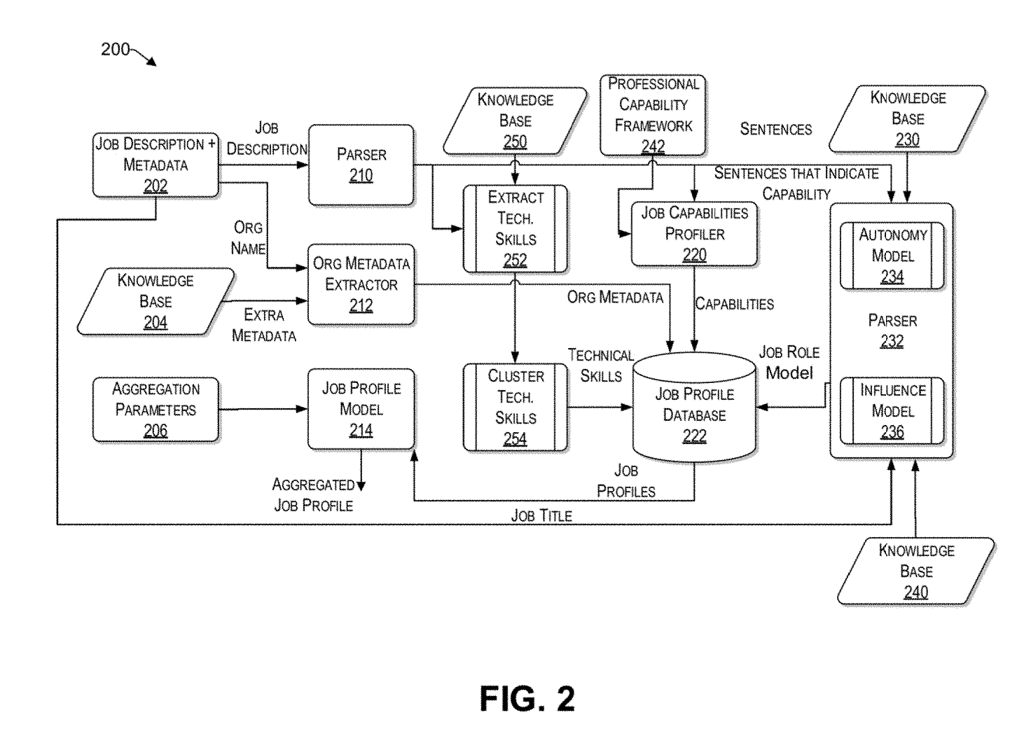

Reference now is made to FIG. 2, which is a block diagram 200 of a system that automatically creates job capabilities profiles, technical skills profile, and job role level. The job market profile engine 103 obtains the present job postings from various job board(s) 110. Each job posting includes a job description and possible metadata. For example, the possible job posting metadata may comprise a title, a company name, a location, one or more job categories and posting date. The job description text and its corresponding metadata is processed by a parser module of the job market profile engine 103 to extract sentences therefrom.

The job capabilities profiler module 220 of the job market profile engine 103 extracts the professional capabilities of the subject job posting and provides the same to the job profile database 222, which may be the job profile database 118 of FIG. 1.

The professional capability framework (242) used by the capabilities profiler module 220 provides a holistic view of an individual's (e.g., job seeker's) ability to perform in a range of contexts and their potential to improve. It also enables interested parties, such as job seekers, governments, and organizations, to strategically manage workforces in a systematic way to respond to changes.

Professional capabilities include (i) core capabilities, and (ii) leadership capabilities. Table 1 below is an example list of core professional capabilities, consistent with an illustrative embodiment.

TABLE 1
Core Professional Capabilities

| Core Professional | |
|---|---|
| Capability | Relevant Skills |
| Self Management | Work and learn independently, and take |
| (SM) | responsibility for personal actions. |
| Digital Literacy | Use information and communication |
| (DL) | technologies (ICT) to fund, use, and |
| | disseminate information. |
| Teamwork (T) | Work and interact with others including those |
| | from different backgrounds and |
| | professions/disciplines. |
| Communication (C) | Use oral, written and interpersonal |
| | communication to inform, motivate and effect |
| | change. |
| Emotional Judgment | Build rapport and recognize and manage one's |
| (EJ) | own emotions and respond to the emotions of |
| | others. |
| Problem Solving | Create, implement and evaluate the success of |
| (PS) | solutions to authentic (real world and ill-defined) |
| | problems. |
| Innovation (I) | Critically review information and ability to |
| | break away from prevailing mindsets, |
| | implement and evaluate the success of new |
| | ideas. |
| Critical Thinking | Evaluate information using critical and |
| (CT) | analytical thinking and judgement. |
| Global Citizenship | Ability to think, act, relate, and respond to |
| (GC) | socio-cultural elements. |
| Professional Ethics | Ability to be ethical and model professional |
| (PE) | standards of behavior and action. |

Table 1 includes an example list of 10 core professional capabilities. For example, the communication capability (C) is referred to as an individual's ability to use oral, written, and interpersonal communication to inform, motivate, and effect change. Communication and other core professional capabilities such as Critical Thinking, Problem Solving, Teamwork and Emotional Judgement, are salient components in successfully responding to change, enhancing innovation and promoting continuous improvement.

Table 2 below is an example list of leadership capabilities consistent with an illustrative embodiment.

TABLE 2

| Leadership | |
|---|---|
| Capability | Relevant Skills |
| Lead and Develop | Lead and develop people to improve performance, |
| People (L) | talent, and capability. |
| Empower Others (E) | Empower and encourage people in their work |
| | to achieve or exceed agreed objectives. |
| Adapt and Change (A) | Develop and promote responsiveness |
| | and foster the capacity of individuals, groups, |
| | and the organization to be entrepreneurial. |
| Drive Strategic Results | Promote the achievement of excellence and the |
| (D) | attainment of strategic outcomes. |

While core professional capabilities may relate to professionals in general, leadership capabilities are operative to measure capabilities of leaders. By way of example only, and not by way of limitation, Table 2 illustrates four leadership capabilities, namely: Lead and Develop People (L), Empower Others (E), Adapt and Change (A), and Drive Strategic Results (D). These leadership capabilities focus on the skills, knowledge, and motivation to drive business growth. They are salient to all leaders and are operative to complement the core professional capabilities.

In one embodiment, the job role model provides the job role level. The job role level is computed by the aggregation of autonomy score and influence score. The influence score is computed from the influence model, and the autonomy score is computed by an autonomy model. In one embodiment, the autonomy model computes the autonomy score by matching verbs in the relevant sentences to those against a standard mapping to verbs to autonomy scores stored in knowledge base 240. The autonomy scores are first computed at the sentence level, and aggregated to compute the autonomy level at the job level. In this embodiment, the influence model computes the influence score by matching the job title from the job description metadata 202 with the standardized job titles and their influence scores stored in knowledge base 230. Table 2 below is an example list of influence levels, sometimes referred to herein as influence models, consistent with an illustrative embodiment.

TABLE 3
Job Influence Levels

Lead the organization
Lead the business/function
Lead operations
Lead others
Lead self

By way of example only, and not by way of limitation, Table 3 illustrates five Influence levels. For each subject job dimension, an influence score is determined by the job market profile engine 103. The score may be alpha-numeric (e.g., 0 to 10, A to F), descriptive (e.g., none, low, medium, and high), based on color (e.g., red, green, and yellow), or any other suitable rating scale. In one embodiment, the job role level comprises: Entry, Developing, Intermediate, Proficient, and Advanced.

It will be understood that some capabilities have a close relationship with others between the leadership capabilities and core capabilities discussed herein. For example, teamwork generally is in harmony with communication. Similarly, the core professional capability of problem solving usually is found with the core professional capability of critical thinking. Where problem solving focuses on using the tools and techniques to solve problems, and critical thinking is the cognitive element behind the problem solving.

Referring back to FIG. 2, the second parser 232 used by the autonomy model module 234 and the influence model module 236 to provide a job role level score to the job profile database 222 for the subject job. The job description and job metadata 202 may not include sufficient terms from which to ascertain the autonomy model and/or the influence model. In this regard, one or more knowledge bases 230 and 240, respectively, may be referred to receive additional context (e.g., metadata) related to the autonomy model and influence model. In embodiment, the autonomy model is provided by a reference look-up table in knowledge base 230 based on salient verbs that are found in the sentences provided by a first parser 210. The influence model module 236 may receive the job title directly from the received job description and metadata 202 of a job posting and standardized titles and their influence scores from knowledge base 240.

In one embodiment, the specific technical skills 252 can be extracted in view of information provided by the knowledge base 250. In addition, the extracted specific technical skills 410 are clustered by semantic relevancy for each job dimension 254. For example, the terms “big data techniques” and “map-reduce” are relevant because map-reduce is one of big data techniques. Therefore, they are placed into the same cluster because of their relevance. The resulting technical skills are stored in the job profile database 222.

In one embodiment, there is an organization metadata extractor module 212 that is operative to provide additional context to the general job description by referring to a knowledge base 204 to extract additional related metadata therefrom. For example, a position may indicate an opening for a “senior DRAM design engineer,” in a named company, the knowledge base 204, may provide an additional information like the size of the company, the number of employees, locations, organization structure etc., (e.g., by way of metadata), to the job profile database 222. The job profile database 222 is operative to receive job description data for the variety of jobs of the job market. The job market profile engine 103 can provide a focused job profile model 214 based on aggregation parameters that may be provided by an interested party. Thus, based on the information provided to the job profile database 222 and the aggregation parameters, the job market profile engine 103 can create a profile model 214 for a job. The aggregation parameters are based on various job dimensions, which may include, without limitation, the following parameters: job post-date, profession, job role, job location, number of employees, type of organization, industry, etc.

The relevant professional capabilities can be identified by the system of FIG. 2. in different ways. In a typical job description, the beginning several sentences describe the company, followed by skill involvements for the job, and involved candidate qualifications. Sentences in the second paragraph may indicate different kinds of professional capabilities. For example, the sentence “Excellent communication skills” explicitly indicates communication capability, while the sentence “Develop and maintain a productive working relationship with project sponsors, customers, vendors, and other key stakeholders” may implicitly infer strong communication capability. Also, some sentences in the job posting may only depict solicited technical capabilities.

In one embodiment, to identify professional capabilities indicated explicitly or implicitly in job postings, each job description 202 is segmented into individual sentences by the first parser 210. In one embodiment, both implicitly inferred and explicitly stated capabilities can be identified using NLP. From these sentences, the job capabilities profiler 220 identifies professional capability involvements. In one embodiment, prior to applying the job capabilities profiler 220, each sentence is cleaned up to remove leading and trailing non-alphabet characters. Also, only the sentences with at least two words are kept for classification.

In one embodiment, to create a training set for machine learning, domain experts may initially manually annotate each of these sentences for possible professional capabilities included therein. Each sentence could have zero, one, or more capabilities. When there are zero capabilities in a sentence, it may indicate that the sentence describes an organization in general terms or characterizes the perks and/or benefits of the position. Other sentences may be annotated with one or more capability class labels. The annotated sentences may be used in classification model training and testing in the context of machine learning. Subsequent job postings can then be processed through the trained classifier to create capability profiles for the jobs. These capability profiles, along with technical skills, and job role levels can then be aggregated by the job profile model 214 in several ways, such as by title, profession, location, or a combination thereof, as indicated by the aggregation parameters input 206.

### Example Hierarchical Classification Structure

As discussed above, the dataset of each job posting includes sentences annotated with zero or more capabilities. To identify capabilities indicated by a text, a classification method is used that takes unstructured text as an input and produces one or more classes as the output.

In one embodiment, neural network based Natural Language Classifier (NLC) is used to leverage its combined unstructured text processing and classification. This NLC can help the job market profile engine 103 understand the language of short texts and make predictions about how to handle them. A classifier learns from your example data and then can return information for texts that it is not trained on. Thus, it can mimic the human ability to classify phrases into categories via deep learning, even if it has not seen the identical phrase before. NLC takes short text as an input, interprets the intent behind the text using deep learning techniques and returns corresponding classes with associated confidence levels.

It will be understood that while some sentences may indicate certain capabilities, these capabilities may refer to the company instead of the job being advertised. Therefore, these sentences should be marked irrelevant (and therefore excluded) regardless of capabilities included therein.

Further, in a job posting, some sentences may describe technical skills rather than professional capabilities. Hence, in one embodiment, to be an effective classification system, at least two types of intents inherent in the text are identified: (i) whether a sentence indicates capabilities, and (ii) which specific capabilities the sentence indicates. For these reasons, in one embodiment multiple NLC models may be used, referred to herein as classifiers.

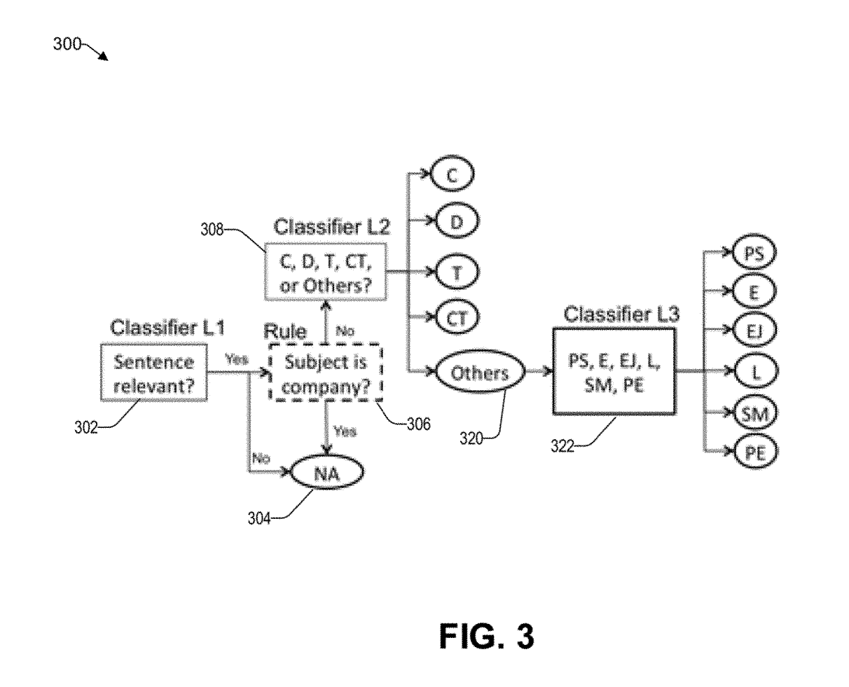

In this regard, reference is made to FIG. 3 which is an example capability extraction architecture 300, consistent with an illustrative embodiment. With a sentence as an input, the job market profile engine 103 initially determines whether a sentence includes one or more capabilities (or zero). A binary NLC, referred to in FIG. 3 as classifier L1 is used to exclude irrelevant sentences, (e.g. sentences that do not imply any professional capability involvements), thereby reducing the computational complexity of the job market profile engine 103.

For example, the sentence “define project requirements” does not indicate a professional capability. Applicants have identified that in a typical job posting, more than half of the sentences do not give an inference for a professional capability. Accordingly, by virtue of the classifier L1, a substantial number of sentences can be eliminated (i.e., 304 in architecture 300) from further processing, thereby improving the performance of the ACPS 116.

If a sentence is identified to include capabilities (i.e., “Yes” at decision block 302), the job market profile engine 103 further examines if the sentence indicates capabilities for the job or the hiring company. At block 306, the job market profile engine 103 determines whether the subject of the sentence is about the hiring company or the candidate/position. In one embodiment, this module 306 is implemented with Alchemy API, which analyzes each sentence (or relative clauses) to understand its subject and object. The module 306 determines whether the subject sentence is about the hiring company. If so, (i.e., “Yes” at module 306), the sentence is filtered out (i.e., removed) from further processing.

However, if a sentence is relevant (i.e., “No” at module 306) and it indicates the capability involvements for the candidate/position (i.e., “Yes” at module 302), then the sentence is further processed by the job market profile engine 103 to detect specific capabilities at module 308. In various embodiments, a single NLC model can detect all the professional capabilities (e.g., 10) or can be split into two groups: one for high volume capabilities and the other for low volume capabilities. Accordingly, in the example of FIG. 3, two NLC models are trained. For example, sentences are sent to Classifier L2 to determine capabilities C, D, T, and CT. If one of these capabilities is not identified (i.e., others 320), then the job market profile engine 103 uses classifier L3 for further processing to detect 322 the remaining capabilities (e.g., PS, E, EJ, L SM, and PE).

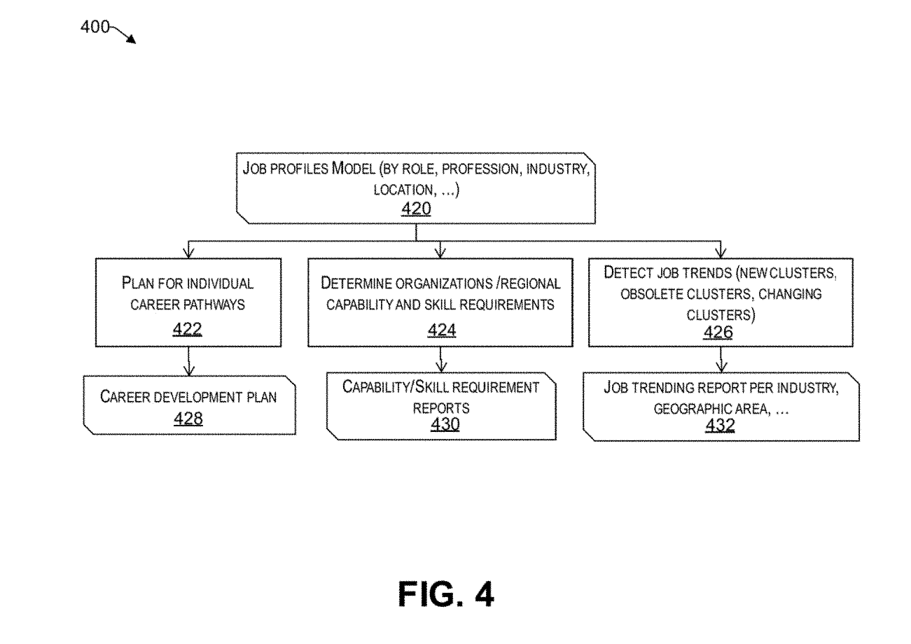

Reference now is made to FIG. 4, which is a conceptual block diagram 400 of a system that uses the job profile model 214 to create different reports and recommendations depending on different use cases, consistent with an illustrative embodiment. At block 420, Job profile model 214 is used to aggregate jobs from job market along various job dimensions. For example, the job profiles are identified by at least one of: a role, profession, industry, and location. By virtue of the identified job profiles 420 provided by the job market profile engine 103, various individuals and agencies can be provided guidance. For example, individual career pathways can be planned 422 by generating a career development plan 428 that accommodates the job profiles for one or more dimensions selected by an individual. In one embodiment, an organization's and/or regional professional capability, and technical skill requirements can be determined 424 to generate a capability and/or skill requirement report 430 to an interested party. In one embodiment, job trends can be identified 426 for one or more dimensions selected by an interested party. For example, new clusters, clusters that are obsolete, and clusters that are changing in time can be identified. From this data, job trending reports may be generated 432, which may be for an industry, geographic area, etc.

### Example Process

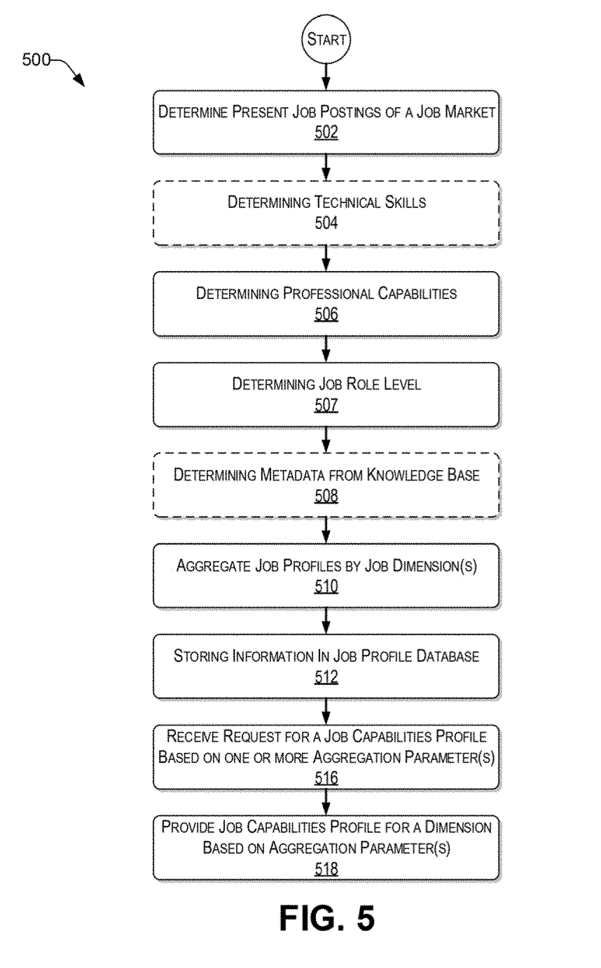

With the foregoing overview of the architecture 100, block diagram 200 of a job capabilities profile system, example professional profile capability extraction architecture 300, and a conceptual block diagram 400 of a system that automatically creates a job capabilities profile, it may be helpful now to consider a high-level discussion of an example process. To that end, FIG. 5 presents an illustrative process 500 for a computerized determination of the status of a job market. Processes 500 is illustrated as a collection of blocks in a logical flowchart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. The order in which the operations are described is not intended to be construed as a limitation, and any number of the described blocks can be combined in any order and/or performed in parallel to implement the process. For discussion purposes, the process 500 is described with reference to the architecture 100 of FIG. 1.

At block 502, the job market profile engine 103 determines the present job postings of a job market. For example, the job market profile engine 103 receives the present job postings from various job boards 110. Each job posting may comprise a title, a company name, a location, one or more job profession categories, posting date, and a job description text.

In one embodiment, at block 504, for each job posting, the technical skills are determined. In one example, the technical skills can be extracted in view of information provided by the knowledge base 412 as supplemental information for each job posting.

At block 506, the professional capabilities are determined by the job market profile engine 103. Determining the professional capabilities comprises segmenting the job description of the subject job posting into individual sentences by a parser of the job market profile engine 103. In one embodiment, the sentences are cleaned up to remove leading and trailing non-alphabet characters, thereby reducing the number of sentences to be processed later. Determining the professional capabilities further comprises determining the capabilities based on professional capability framework 242 using natural language processing.

At block 507 the job role level is determined based on the autonomy model and the influence model for each job posting. Determining job autonomy and influence levels may involve additional data sources, like 230 and 240 of FIG. 2.

In one embodiment, at block 508, the job market profile engine 103 receives ancillary data, sometimes referred to herein as metadata, from the third-party knowledge base 112, which provides context for a subject job posting. In various embodiments, the data from the third-party knowledge base 112 may be used to create an autonomy model, create an influence model, and provide additional context for each job position analyzed by the job market profile engine 103.

At block 510, the job market profile engine 103 aggregates the professional capabilities of the received job postings by one or more job dimensions.

At block 512, the technical skills (if available) and professional capabilities for each job position, as well as the aggregate information for each job dimension are stored in a job profile database 118 as reference data.

At block 516, upon receiving a request for a job profile based on one or more aggregation parameters from an interested party (e.g., 101), at block 518 the job profile for a dimension based on the one or more aggregation parameters is provided to the interested party (e.g., on a user interface of their computing device 102).

### Example Job Capability Profile Analysis

Upon completing the training of the classification models as described previously, the job market profile engine 103 can create job capability profiles from the collected job postings. Each job posting is segmented into sentences, the sentences are cleaned up, and capabilities are identified for each sentence. The union of the capabilities of all sentences are the set of capabilities for the job posting. The job market profile engine 103 then aggregates the job postings based on one or more job dimensions. The job postings typically include some metadata, such as job title, company, profession, industry and location (city and country). If such relevant metadata is not immediately provided, a third-party knowledge base 112 can be referred to provide the missing information.

In some embodiments, job titles can be normalized against some common job taxonomy. These normalized job titles become another metadata for the job and a new aggregation parameter.

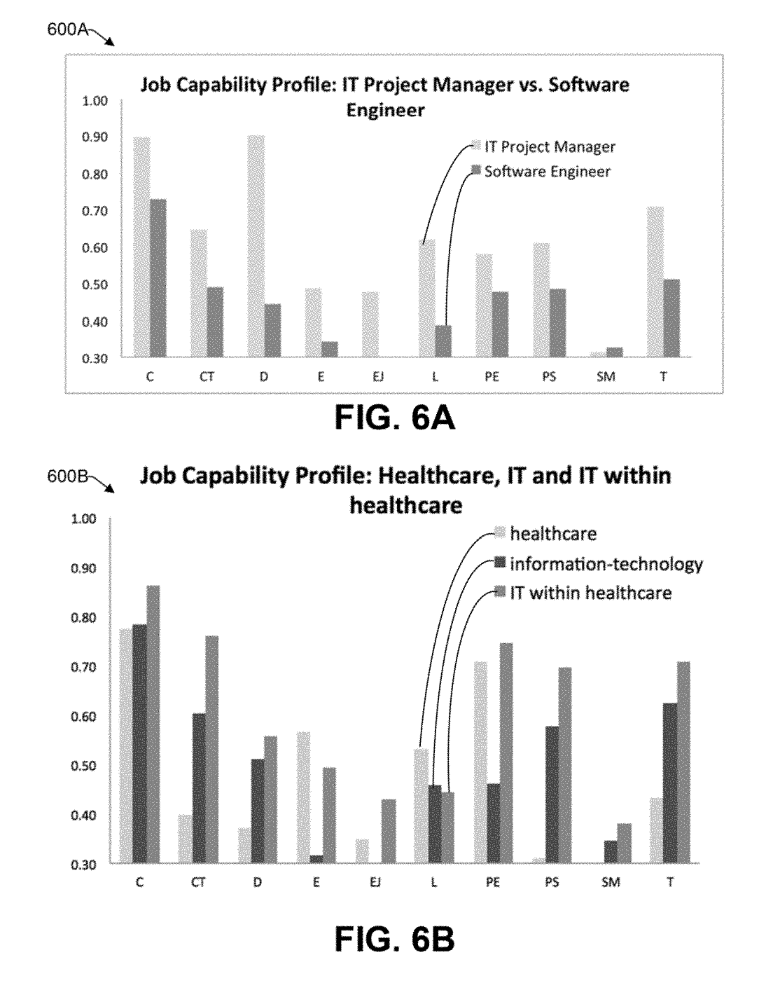

To create job capability profiles along a dimension, such as normalized job titles, the job market profile engine 103 counts the number of jobs by job title and by capabilities within the title. For each job title, the percentage of jobs that relate to a specific capability is calculated. In this regard, FIG. 6A illustrates an example capability profile for two different job titles, namely “IT Project Manager” vs. “Software Engineer.” The capability profile indicates that for information technology (IT) Project Managers, 90% of jobs involve C (Communication) capability, while only 70% of Software Engineer jobs indicated capability C (Communication) involvement in the job postings. Thus, in the example of FIG. 6A, a higher percentage of IT Project Manager jobs involve more professional capabilities compared to Software Engineer jobs. Particularly, the capability D (Drive Strategic Results) is involved for most of the IT Project Manager jobs (90%) compared to only in 50% of Software Engineer jobs.

FIG. 6B illustrates example capability profiles for different professions, namely IT, Healthcare, and IT within Healthcare. Again, both professions highly involve C (Communication) capability. However, CT (Critical Thinking), D (Drive Strategic Results), PS (Problem Solving) and T (Teamwork) are highly desirable capabilities for IT profession, but somehow are not very commonly requested by Healthcare profession. Instead, PE (Professional Ethics) is involved in more than three-fourths of the jobs for Healthcare professionals. For example, based on this information, a healthcare professional interested in expanding their career into IT, can develop the appropriate professional capability to make a successful transition.

Unexpected results are obtained for IT within healthcare. For example, almost all professional capabilities (except for “lead and develop people,” L), are more often involved than the capabilities of individual professions of IT and healthcare. Additionally, PE (Professional Ethics) is highly desired for IT-within-healthcare jobs, even more so than for the pure healthcare jobs. Further, a higher percentage of jobs involve EJ (Emotional Judgement) compared to just healthcare jobs. In addition, PS (Problem Solving), CT (Critical thinking) and T (Teamwork) are involved even more compared to IT jobs in isolation. While IT, software, and healthcare are discussed in the context of FIGS. 6A and 6B, it will be understood that other dimensions of of interest can be analyzed as well. Accordingly, by virtue of the thousands or even hundreds of thousands of job postings that were automatically harvested by the job market profile engine 103, a subscriber to the service described herein can gain valuable insight into the demands and trends of professional capabilities in their one or more dimensions of interest.

Unlike previous approaches, which are labor intensive and retrospective, the job capability profiling methods and systems discussed herein provide a real-time data-driven approach for identification of the salient job capabilities for new and emerging jobs and job categories, without the need to first modify the taxonomy.

### Example Computer Platform

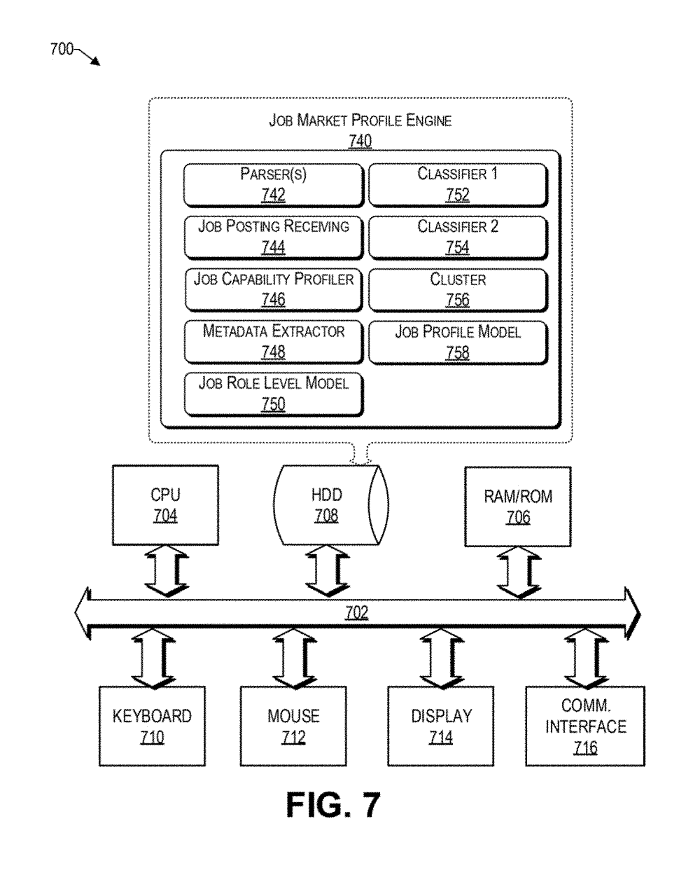

As discussed above, functions relating to job profiling can be performed with the use of one or more computing devices connected for data communication via wireless or wired communication, as shown in FIG. 1 and in accordance with the process 500 of FIG. 5. FIG. 7 provides a functional block diagram illustration of a computer hardware platform. In particular, FIG. 7 illustrates a network or host computer platform 700, as may typically be used to implement a server, such as the server supporting the job board(s) 110, the knowledge base 112, and the ACPS 116 of FIG. 1.

The computer platform 700 may include a central processing unit (CPU) 704, random access memory (RAM) and/or read only memory (ROM) 706, a hard disk drive (HDD) 708, a keyboard 710, a mouse 712, a display 714, and a communication interface 716, which are connected to a system bus 702.

In one embodiment, the HDD 708, has capabilities that include storing a program that can execute various processes, such as the job market profile engine 740, in a manner described herein. The job market profile engine 740 may have various modules configured to perform different functions.

For example, the job market profile engine 740 may include one or more parser modules 742. For example, a first parser may be operative to segment each job description into individual sentences while a second parser may use an autonomy model module and/or influence model module to provide a job role level score to the job profile database.

There may be a job posting receiving module 744 operative to receive job postings from one or more job boards 110 of FIG. 1. There may be a job capability profiler module that is operative to identify professional capability and technical skill involvements of each extracted job posting. There may be a metadata extractor 748 operative to extract from the job description, various relevant metadata therefrom, such as salary, job title, geographical location, industry, etc. The metadata extractor module 748 may refer to third party resources, such as the third-party knowledge base 112, to find more information about the location, size, etc., of the employer, if available.

The job market profile engine 740 may further include a job role level model module 750 that is operative to combine a score of the autonomy model and a score of the influence model into a unified representative job role level score. There may be one or more classifier modules 752 to 756. For example, a first classifier module 752 may be used to exclude irrelevant sentences, a second classifier module 754 may be used to identify professional capabilities, and a clustering module 756 may be used to cluster technical skills. There may also be a job profile model module 758 that is operative to provide a job profile model based on aggregation parameters that may be provided by an interested party for a job dimension.

In one example a program, such as Apache™, can be stored for operating the system as a Web server. In one embodiment, the HDD 708 can store an executing application that includes one or more library software modules, such as those for the Java™ Runtime Environment program for realizing a JVM (Java™ virtual machine).

### CONCLUSION

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to a flowchart illustration and/or block diagram of a method, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the FIGS. herein illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A computing device comprising:
a processor;
a network interface coupled to the processor to enable communication over a network;
a storage device coupled to the processor;
a job market profile engine software stored in the storage device, wherein an execution of the software by the processor configures the computing device to perform acts comprising:
determining available job postings of a job market;
for each job posting:
determining one or more technical skills related to the job posting;
determining a job role level related to the posting; and
determining one or more professional capabilities related to the job posting;
aggregating professional capabilities by job dimensions;
storing the determined technical skills, job role level, and the professional capabilities of each job posting and the aggregated professional capabilities, as reference data in a database; and
providing a job capability profile for one or more job dimensions, based on the stored reference data in the database.

2. The computing device of claim 1, wherein determining the professional capabilities comprises:
determining one or more core capabilities; and
determining one or more leadership capabilities.

3. The computing device of claim 2, wherein the core capabilities include at least one of: (i) self-management, (ii) digital literacy, (iii) teamwork, (iv) communication, (v) emotional judgment, (vi) problem solving, (vii) innovation, (viii) critical thinking, (ix) global citizenship, and (x) professional ethics.

4. The computing device of claim 2, wherein the professional capabilities include at least one of the following leadership capabilities: (i) leading and developing people, (ii) empowering others, (iii) being able to adapt and change, and (iv) driving strategic results.

5. The computing device of claim 1, wherein, for each job posting, determining the job role level related to the job posting further comprises:
identifying an autonomy model; and
identifying an influence model.

6. The computing device of claim 5, wherein execution of the software by the processor further configures the computing device to perform the act of determining a job role level score based on the autonomy model and the influence model.

7. The computing device of claim 5, wherein identifying an autonomy model comprises:
identifying one or more verbs from the one or more individual sentences; and
retrieving, from a reference table, the autonomy model based on the identified one or more verbs.

8. The computing device of claim 1, wherein, for each job posting, determining the one or more professional capabilities related to the job posting comprises:
segmenting a job description text of the job posting into one or more sentences; and
cleaning up the one or more sentences by removing any leading and trailing non-alphabet characters from each sentence.

9. The computing device of claim 8, wherein, for each job posting, determining the one or more professional capabilities related to the job posting further comprises:
upon determining that a sentence of the one or more sentences is irrelevant, discarding the irrelevant sentence and identifying the remaining one or more sentences as relevant; and
determining one or more professional capabilities from the sentences identified as relevant, based on a framework of professional capabilities using natural language processing (NLP).

10. The computing device of claim 8, wherein execution of the software by the processor further configures the computing device to perform the act of excluding sentences that do not include a technical skill or a professional capability by applying a neural network based natural language classifier (NLC) on the sentences.

11. The computing device of claim 8, wherein, for each job posting, determining the one or more professional capabilities related to the job posting further comprises:
determining whether there is at least one of (i) an explicit and (ii) an implicit description of a professional capability; and
upon determining that there is an implicit description of a professional capability, using natural language processing (NLP) to identify the implicit description of the professional capability.

12. The computing device of claim 8, wherein execution of the software by the processor further configures the computing device to perform the act of excluding sentences that include one or more job capabilities, upon determining via a neural network based natural language classifier (NLC), that the one or more job capabilities relate to a company and not a job.

13. The computing device of claim 8, wherein execution of the software by the processor further configures the computing device to perform the act of clustering technical skills by semantic relevancy for each job dimension.

14. The computing device of claim 1, wherein execution of the software by the processor further configures the computing device to perform the act of extracting additional metadata from one or more knowledge bases for a job posting.

15. A non-transitory computer readable storage medium tangibly embodying a computer readable program code having computer readable instructions that, when executed, causes a computer device to carry out a method of characterizing a job market, the method comprising:
determining available job postings of a job market;
for each job posting:
determining one or more technical skills related to the job posting;
determining a job role level related to the posting; and
determining one or more professional capabilities related to the job posting;
aggregating professional capabilities by job dimensions;
storing the determined technical skills, job role level, and the professional capabilities of each job posting and the aggregated professional capabilities, as reference data in a database; and
providing a job capability profile for one or more job dimensions, based on the stored reference data in the database.

16. The method of claim 15, wherein, for each job posting, determining the one or more professional capabilities related to the job posting comprises:
segmenting a job description text of the job posting into one or more sentences; and
cleaning up the one or more sentences by removing any leading and trailing non-alphabet characters from each sentence.

17. The method of claim 16, wherein, for each job posting, determining the one or more professional capabilities related to the job posting further comprises:
upon determining that a sentence of the one or more sentences is irrelevant, discarding the irrelevant sentence and identifying remaining one or more sentences as relevant; and
determining one or more professional capabilities from the sentences identified as relevant, based on a framework of professional capabilities using natural language processing (NLP).

18. The method of claim 16, wherein, for each job posting, determining the one or more professional capabilities related to the job posting further comprises:
determining one or more core capabilities; and
determining one or more leadership capabilities.

19. The method of claim 17, wherein execution of the software by the processor further configures the computing device to perform the act of determining a job role level score based on the autonomy model and the influence model.

20. The method of claim 17, wherein, for each job posting, determining the one or more professional capabilities related to the job posting further comprises:
determining whether there is at least one of (i) an explicit and (ii) an implicit description of a professional capability; and
upon determining that there is an implicit description of a professional capability, using natural language processing (NLP) to identify the implicit description of the professional capability.
